(19) United States
(12) Patent Application Publication
(10) Pub. No.: US 2024/0251323 A1
(43) Pub. Date: Jul. 25, 2024

(54) ELECTRONIC DEVICE FOR PROCESSING WIRELESS SIGNALS FOR SATELLITE COMMUNICATION AND OPERATING METHOD THEREOF

(71) Applicant: Samsung Electronics Co., Ltd., Suwon-si (KR)

(72) Inventors: Hong KIM, Suwon-si (KR); Sohmann KIM, Suwon-si (KR); Hyejeong KIM, Suwon-si (KR)

(21) Appl. No.: 18/430,225

(22) Filed: Feb. 1, 2024

Related U.S. Application Data
(63) Continuation of application No. PCT/KR2024/000787, filed on Jan. 16, 2024.

(30) Foreign Application Priority Data
Jan. 19, 2023 (KR) 10-2023-0007749
Feb. 22, 2023 (KR) 10-2023-0023807
Mar. 15, 2023 (KR) 10-2023-0034025

(51) Int. Cl. H04W 36/32; H04W 36/00; H04W 36/08; H04W 84/06

(52) U.S. Cl. CPC H04W 36/326; H04W 36/008357; H04W 36/08; H04W 84/06

(57) ABSTRACT

An electronic device may include: a communication circuit configured to support cellular communication through a terrestrial network and a non-terrestrial network, a memory configured to store mapping data obtained by mapping identification information of the non-terrestrial network and a service supported by the non-terrestrial network, and at least one communication processor. One or more of the at least one communication processor may be configured to: search for a cell corresponding to another network within a specified distance with reference to a location of the electronic device, based on the non-terrestrial network having a highest priority with respect to communication connection, determine, based on another network having a lower priority than the non-terrestrial network being found, whether an emergency call is supported on another network having the lower priority, and perform, based on the emergency call being supported on another network having the lower priority, camp-on on another network having the lower priority, wherein the camp-on includes monitoring, by the electronic device, system information and paging information in a newly selected cell based on cell reselection.

### CROSS-REFERENCE TO RELATED APPLICATIONS

This application is a continuation of International Application No. PCT/KR2024/000787 designating the United States, filed on Jan. 16, 2024, in the Korean Intellectual Property Receiving Office and claiming priority to Korean Patent Application Nos. 10-2023-0007749, filed on Jan. 19, 2023, 10-2023-0023807, filed on Feb. 22, 2023, and 10-2023-0034025, filed on Mar. 15, 2023, in the Korean Intellectual Property Office, the disclosures of each of which are incorporated by reference herein in their entireties.

### BACKGROUND

### Field

The disclosure relates to an electronic device and, for example, to an electronic device for processing signals for satellite communication and an operating method thereof.

### Description of Related Art

To meet the demand for wireless data traffic having increased since deployment of 4G communication systems, efforts have been made to develop an improved 5G or pre-5G communication system. Therefore, the 5G or pre-5G communication system may also be referred to as a “beyond 4G network” communication system or a “post LTE” system. In addition to the bands (e.g., 6 GHz or lower bands) used in LTE, the 5G communication system is considered to be implemented in ultrahigh frequency (mmWave) bands (e.g., 6 GHz or higher bands) so as to accomplish higher data rates. Beamforming, massive multiple-input multiple-output (massive MIMO), full dimensional MIMO (FD-MIMO), array antenna, analog beam forming, large scale antenna techniques are under discussion in 5G communication systems.

Recently, provision of a communication service using not only a base station fixed on the ground but also an entity not fixed on the ground is considered in a 5 generation communication system. According to an embodiment, implementation of cellular communication using satellites is considered in the 5 generation communication system. An electronic device may perform cellular communication using satellites when it is difficult to connect to a base station. The cellular communication using satellites may implement wider coverage compared to cellular communication using the base station, by the characteristics of the satellites moving around the orbit of the Earth. Cellular communication using satellites has attracted attention in the perspective of reduction of a shadow area where the communication service is impossible.

However, cellar communication using satellites has a lower transmission speed and/or reception speed than cellular commutation using a base station, and may thus be used in performing limited services (e.g., a short message service (SMS) or a voice call). The electronic device using cellular communication may attempt data transmission and/or reception through the cellular communication using a base station, and may perform the cellular communication using satellites as an auxiliary may refer, for example, to when connection to the base station is not established.

An electronic device may use a terrestrial network (TN) or a non-terrestrial network (NTN) using 3GPP standard communication. The electronic device may establish a communication connection, based on a priority, regardless of the state of a satellite base station. In this case, the satellite base station is connected according to the priority even in a case where the electronic device does not use the satellite base station, which may thus cause shortage of internal resources.

In addition, the satellite base station may fail to provide a specific service (e.g., an emergency call). In this case, the electronic device may need to connect to another base station having a next higher priority, rather than the satellite base station. However, the electronic device may connect to the satellite base station having the highest priority, rather than the base station having the next higher priority, which can provide a specific service (e.g., an emergency call) according to the priority. In this case, the electronic device fails to be provided with the specific service (e.g., the emergency call), and thus the usability decreases.

### SUMMARY

Embodiments of the disclosure provide an electronic device that may prevent and/or reduce overload of a satellite base station and enhance the usability by establishing communication connection in consideration of not only the priority but also the type of a service provided by a base station.

An electronic device according to various example embodiments may include: a communication circuit configured to support cellular communication through a terrestrial network and a non-terrestrial network, a memory configured to store mapping data obtained by mapping identification information of the non-terrestrial network and a service supported by the non-terrestrial network, and at least one communication processor. One or more of the at least one communication processor may be configured to: search for a cell corresponding to another network within a specified distance with reference to a location of the electronic device, based on the non-terrestrial network having a highest priority with respect to communication connection, determine, based on another network having a lower priority than the non-terrestrial network being found, whether an emergency call is supported on another network having the lower priority, and perform, based on the emergency call being supported on another network having the lower priority, camp-on on another network having the lower priority, wherein the camp-on includes monitoring, by the electronic device, system information and paging information in a newly selected cell after cell reselection.

A method of operating an electronic device for satellite communication according to various example embodiments may include: searching for a cell corresponding to another network within a specified distance with reference to a location of the electronic device, based on a non-terrestrial network having a highest priority with respect to communication connection, determining, based on another network having a lower priority than the non-terrestrial network being found, whether an emergency call is supported on another network having the lower priority, and performing camp-on on another network having the lower priority, based on the emergency call being supported on another network having the lower priority, wherein the camp-on includes monitoring, by the electronic device, system information and paging information in a newly selected cell after cell reselection.

An electronic device according to various example embodiments of the disclosure can prevent and/or reduce overload of a satellite base station by establishing communication connection to a terrestrial base station according to a condition, instead of establishing communication connection to the satellite base station, based on a priority.

An electronic device according to various example embodiments of the disclosure can enhance the usability by establishing communication connection in consideration of the type of service provided by a base station.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device for supporting legacy network communication and 5G network communication according to various embodiments;

FIG. 3 is a diagram illustrating a protocol stack structure of a network 100 of legacy communication and/or 5G communication according to various embodiments;

FIG. 4 is a diagram illustrating an electronic device and a long-distance communication network environment according to various embodiments;

FIG. 5 is a diagram illustrating a situation in which an electronic device moves to coverage of a cell for providing another service according to various embodiments;

FIG. 6 is a block diagram illustrating an example configuration of an electronic device according to various embodiments;

FIG. 7 is a flowchart illustrating an example communication connection establishment operation of an electronic device according to various embodiments;

FIG. 8 is a flowchart illustrating an example cell searching operation of an electronic device according to various embodiments; and

FIG. 9 is a flowchart illustrating an example operation of receiving a plurality of services from an electronic device, according to various embodiments.

### DETAILED DESCRIPTION

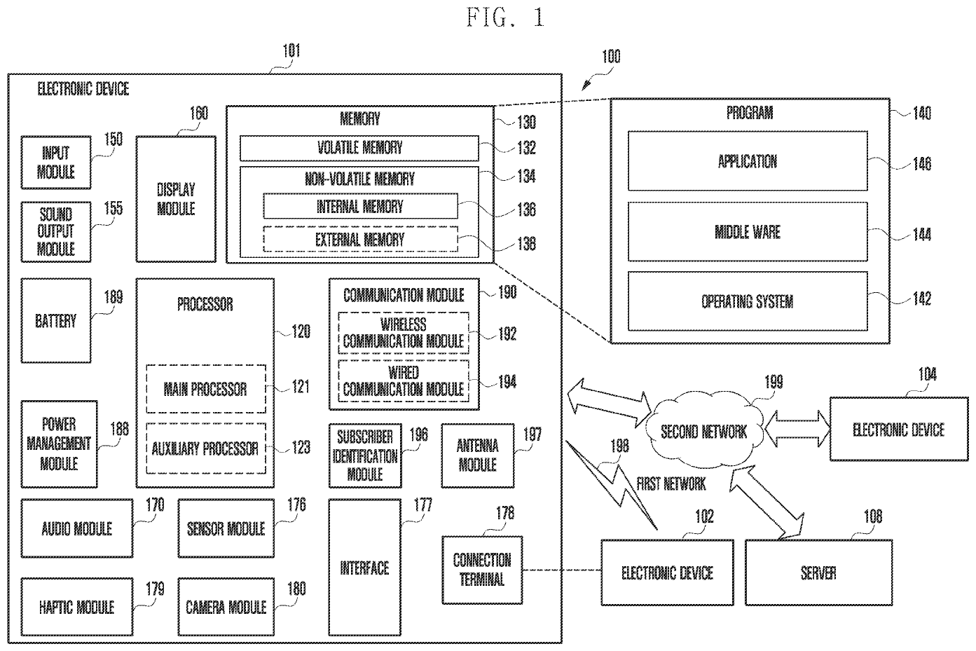

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry (as used herein, including the claims, the term “processor” may include various processing circuitry, including at least one processor, wherein one or more processors of at least one processor may be configured to perform the various functions described herein) and may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

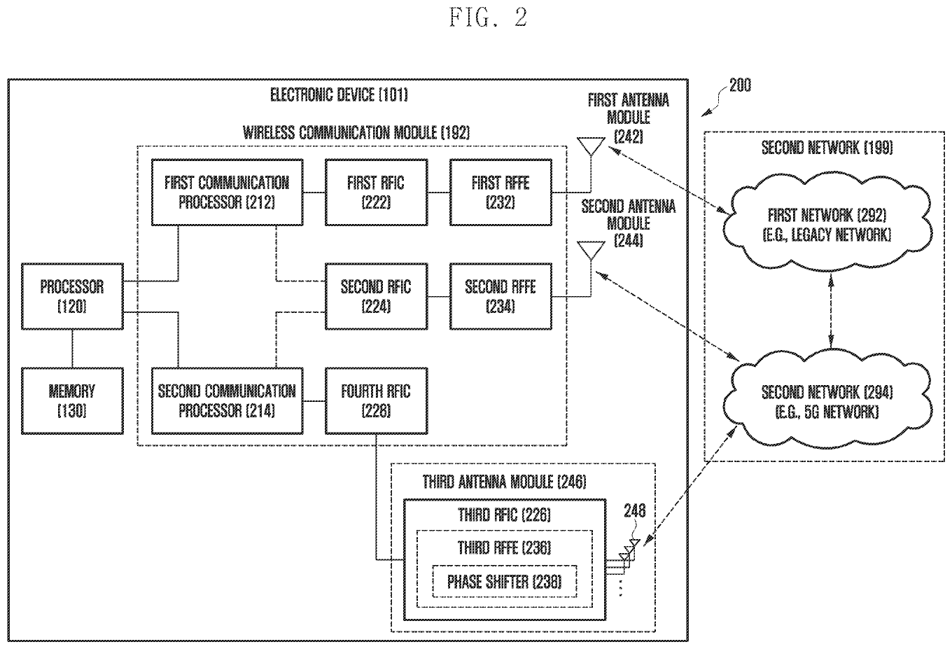

FIG. 2 is a block diagram 200 illustrating an example configuration of an electronic device 101 for supporting legacy network communication and 5G network communication according to various embodiments. Referring to FIG. 2, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor (e.g., including processing circuitry) 120 and the memory 130. The network 199 may include a first network 292 and a second network 294. According to an embodiment, the electronic device 101 may further include at least one component among the components illustrated in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may be included as at least a part of the wireless communication module 192. According to an embodiment, the fourth RFIC 228 may be omitted or may be included as a part of the third RFIC 226.

The first communication processor 212 may include various processing circuitry (as used herein, including the claims, the term “processor”, “communication processor”, or the like, may include various processing circuitry, including at least one processor, wherein one or more processors of at least one processor may be configured to perform the various functions described herein) and may establish a communication channel of a band to be used for wireless communication with the first network 292, and may support legacy network communication via the established communication channel. According to certain embodiments, the first network may be a legacy network including 2G, 3G, 4G, or long term evolution (LTE) network. The second communication processor 214 may include various processing circuitry (as set forth above, and as used herein, including the claims, the term “processor”, “communication processor”, or the like, may include various processing circuitry, including at least one processor, wherein one or more processors of at least one processor may be configured to perform the various functions described herein) and may establish a communication channel corresponding to a designated band (e.g., approximately 6 GHz to 60 GHz) among bands to be used for wireless communication with the second network 294, and may support 5G network communication via the established channel. According to certain embodiments, the second network 294 may be a 5G network defined in 3GPP. Additionally, according to an embodiment, the first communication processor 212 or the second communication processor 214 may establish a communication channel corresponding to another designated band (e.g., lower than 6GHz) among bands to be used for wireless communication with the second network 294, and may support 5G network communication via the established channel. According to an embodiment, the first communication processor 212 and the second communication processor 214 may be implemented in a single chip or a single package. According to certain embodiments, the first communication processor 212 or the second communication processor 214 may be implemented in a single chip or a single package, together with the processor 120, the sub-processor 123, or the communication module 190.

In the case of transmission, the first RFIC 222 may convert a baseband signal generated by the first communication processor 212 into a radio frequency (RF) signal in a range of approximately 700 MHz to 3GHz used for the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal to a baseband signal so that the base band signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) of a Sub6 band (e.g., lower than 6 GHz) used for the second network 294 (e.g., 5G network). In the case of reception, a 5G Sub6 RF signal is obtained from the second network 294 (e.g., a 5G network) via an antenna (e.g., the second antenna module 244), and may preprocessed by an RFFE (e.g., the second RFFE 234). The second RFIC 224 may convert the preprocessed 5G Sub6 RF signal into a baseband signal so that the baseband signal is processed by a corresponding communication processor from among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used for the second network 294 (e.g., 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal to a baseband signal so that the base band signal is processed by the second communication processor 214. According to an embodiment, the third RFFE 236 may be implemented as a part of the third RFIC 226.

According to an embodiment, the electronic device 101 may include the fourth RFIC 228, separately from or as a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHz), and may transfer the IF signal to the third RFIC 226. The third RFIC 226 may convert the IF signal to a 5G Above6 RF signal. In the case of reception, a 5G Above6 RF signal is received from the second network 294 (e.g., a 5G network) via an antenna (e.g., the antenna 248), and may be converted into an IF signal by the third RFFE 226. The fourth RFIC 228 may convert the IF signal to a baseband signal so that the base band signal is processed by the second communication processor 214.

According to an embodiment, the first RFIC 222 and the second RFIC 224 may be implemented as a single chip or at least a part of the single package. According to an embodiment, the first RFFE 232 and the second RFFE 234 may be implemented as a single chip or at least a part of the single package. According to an embodiment, at least one antenna module of the first antenna module 242 or the second antenna module 244 may be omitted, or may be combined with another antenna module so as to process RF signals in a plurality of bands.

According to an embodiment, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., a lower part) of the second substrate (e.g., a sub PCB) separate from the first substrate and the antenna 248 is disposed on another part (e.g., an upper part), so that the third antenna module 246 is formed. By disposing the third RFIC 226 and the antenna 248 in the same substrate, the length of a transmission line therebetween may be reduced. For example, this may reduce a loss (e.g., attenuation) of a signal in a high-frequency band (e.g., approximate 6 GHz to 60 GHz) used for 5G network communication, the loss being caused by a transmission line. Accordingly, the electronic device 101 may improve the quality or speed of communication with the second network 294 (e.g., 5G network).

According to an embodiment, the antenna 248 may be implemented as an antenna array including a plurality of antenna elements which may be used for beamforming. In this instance, the third RFIC 226 may be, for example, a part of the third RFFE 236, and may include a plurality of phase shifters 238 corresponding to a plurality of antenna elements. In the case of transmission, each of the plurality of phase shifters 238 may shift the phase of a 5G Above6RF signal to be transmitted to the outside of the electronic device 101 (e.g., a base station of a 5G network) via a corresponding antenna element. In the case of reception, each of the plurality of phase shifters 238 may shift the phase of the 5G Above6 RF signal received from the outside via a corresponding antenna element into the same or substantially the same phase. This may enable transmission or reception via beamforming between the electronic device 101 and the outside.

The second network 294 (e.g., 5G network) may operate independently (e.g., Stand-Along (SA)) from the first network 292 (e.g., a legacy network), or may operate by being connected thereto (e.g., Non-Stand Alone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access an access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., New Radio (NR) protocol information) for communication with the 5G network may be stored in the memory 230, and may be accessed by another component (e.g., the processor 120, the first communication processor 212, or the second communication processor 214).

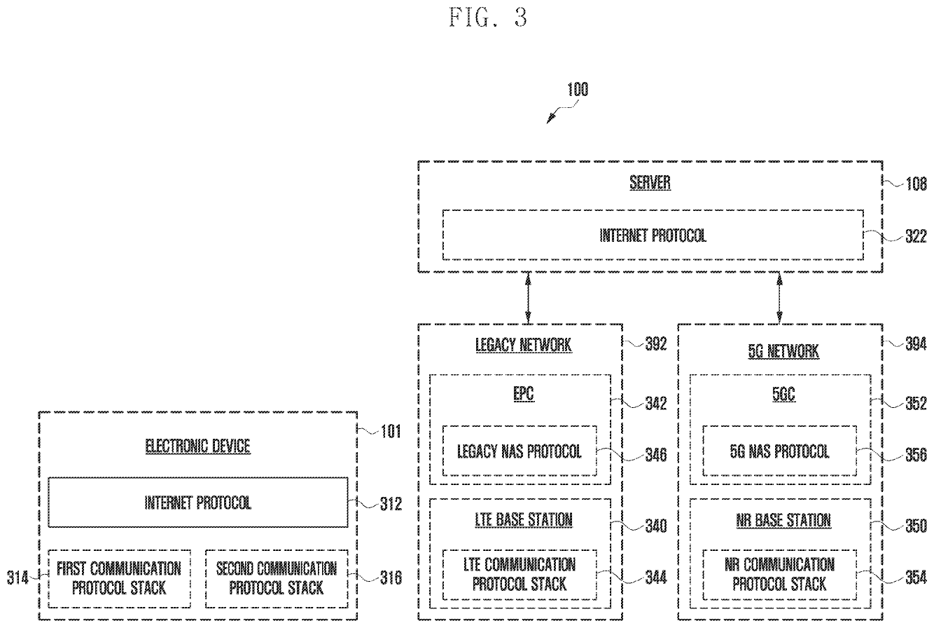

FIG. 3 is a diagram illustrating a protocol stack structure of the network 100 of legacy communication and/or 5G communication according to various embodiments.

Referring to FIG. 3, the network 100 according to an illustrated embodiment may include the electronic device 101, a legacy network 392, a 5G network 394, and the server 108.

The electronic device 101 may include an Internet protocol 312, a first communication protocol stack 314, and a second communication protocol stack 316. The electronic device 101 may communicate with the server 108 through the legacy network 392 and/or the 5G network 394.

According to an embodiment, the electronic device 101 may perform Interne communication associated with the server 108 through the Internet protocol 312 (for example, a TCP, a UDP, or an IP). The Internet protocol 312 may be executed by, for example, a main processor (for example, the main processor 121 of FIG. 1) included in the electronic device 101.

According to an embodiment, the electronic device 101 may perform wireless communication with the legacy network 392 through the first communication protocol stack 314. According to an embodiment, the electronic device 101 may perform wireless communication with the 5G network 394 through the second communication protocol stack 316. The first communication protocol stack 314 and the second communication protocol stack 316 may be executed by, for example, one or more communication processors (for example, the wireless communication module 192 of FIG. 1) included in the electronic device 101.

The server 108 may include an Internet protocol 322. The server 108 may transmit and receive data related to the Internet protocol 322 to and from the electronic device 101 through the legacy network 392 and/or the 5G network 394. According to an embodiment, the server 108 may include a cloud computing server existing outside the legacy network 392 or the 5G network 394. According to an embodiment, the server 108 may include an edge computing server (or a mobile edge computing (MEC) server) located inside at least one of the legacy network or the 5G network 394.

The legacy network 392 may include an LTE eNode B (eNB) 340 and an EPC 342. The LTE eNB 340 may include an LTE communication protocol stack 344. The EPC 342 may include a legacy NAS protocol 346. The legacy network 392 may perform LTE wireless communication with the electronic device 101 through the LTE communication protocol stack 344 and the legacy NAS protocol 346.

The 5G network 394 may include an NR gNB 350 and a 5GC 352. The NR gNB 350 may include an NR communication protocol stack 354. The 5GC 352 may include a 5G NAS protocol 356. The 5G network 394 may perform NR wireless communication with the electronic device 101 through the NR communication protocol stack 354 and the 5G NAS protocol 356.

According to an embodiment, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include a message related to at least one of, for example, security control, bearer setup, authentication, registration, or mobility management. The user data may include, for example, the remaining data except other than the control message.

According to an embodiment, the control plane protocol and the user plane protocol may include a physical (PHY) layer, a medium access control (MAC) layer, a radio link control (RLC) layer, or a packet data convergence protocol (PDCP) layer. The PHY layer may channel-code and modulate data received from, for example, a higher layer (for example, the MAC layer), transmit the data through a radio channel, demodulate and decode the data received through the radio channel, and transmit the data to the higher layer. The PHY layer included in the second communication protocol stack 316 and the NR communication protocol stack 354 may further perform an operation related to beamforming. The MAC layer may logically/physically map, for example, data to a radio channel for transmitting and receiving the data and perform a hybrid automatic repeat request (HARQ) for error correction. The RLC layer may perform, for example, data concatenation, segmentation, or reassembly, and data sequence identification, reordering, or duplication detection. The PDCP layer may perform an operation related to, for example, ciphering of a control message and user data and data integrity. The second communication protocol stack 316 and the NR communication protocol stack 354 may further include a service data adaptation protocol (SDAP). The SDAP may manage allocation of radio bearers on the basis of quality of service (QoS) of user data.

According to certain embodiments, the control plane protocol may include a radio resource control (RRC) layer and a non-access stratum (NAS) layer. The RRC layer may process control, for example, data related to radio bearer setup, paging, or mobility management. The NAS may process, for example, a control message related to authentication, registration, or mobility management.

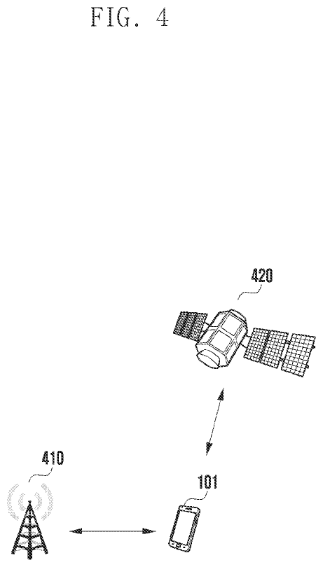

FIG. 4 is a diagram illustrating an electronic device and a long-distance communication network environment according to various embodiments.

An electronic device (e.g., the electronic device 101 of FIG. 1) may transmit and/or receive data through a terrestrial network and/or a non-terrestrial network.

The terrestrial network may refer to a network which can provide data communication through a terrestrial wireless communication device 410. For example, the terrestrial wireless communication device 410 may include a base station located on the ground (for example, fixed on the ground). The terrestrial wireless communication device 410 may support at least one communication scheme among various communication schemes supportable by the electronic device 101. For example, the terrestrial wireless communication device 410 may include an eNodeB or a gNodeB, but the type there of is not limited.

The non-terrestrial network may refer to a network which can provide data communication through a non-terrestrial wireless communication device 420. For example, the non-terrestrial wireless communication device 420 may include at least one of various communication devices such as a base station and a relay, which are not located on the ground. For example, the non-terrestrial wireless communication device 420 may include satellites and/or an unmanned aerial vehicle, but the type thereof is not limited. For example, the satellites may include a low-earth orbit (LEO) satellite, a medium-earth orbit (MEO) satellite, a geostationary earth orbit (GEO) satellite, and/or a high elliptical orbit (HEO) satellite.

The non-terrestrial wireless communication device 420 may support at least one of various wireless communication schemes. For example, the non-terrestrial wireless communication device 420 may support an NR non-terrestrial network (NR NTN) defined by the 3^{rd} generation partnership project (3GPP). Alternatively, the non-terrestrial wireless communication device 420 may also support a communication scheme based on various communication standards such as LTE, global system for mobile communications (GMS), and code-division multiple access (CDMA), but the type thereof is not limited.

The terrestrial network and the non-terrestrial network may include networks which are independent from each other. The terrestrial network and the non-terrestrial network may be included in one or more networks (e.g., networks provided by the same operator) which are associated with each other.

The electronic device 101 may perform wireless communication through the non-terrestrial network when communication with the terrestrial network is not possible or is not smoothly performed. In some cases, the electronic device 101 may perform wireless communication through the non-terrestrial network, regardless of the state of communication with the terrestrial network.

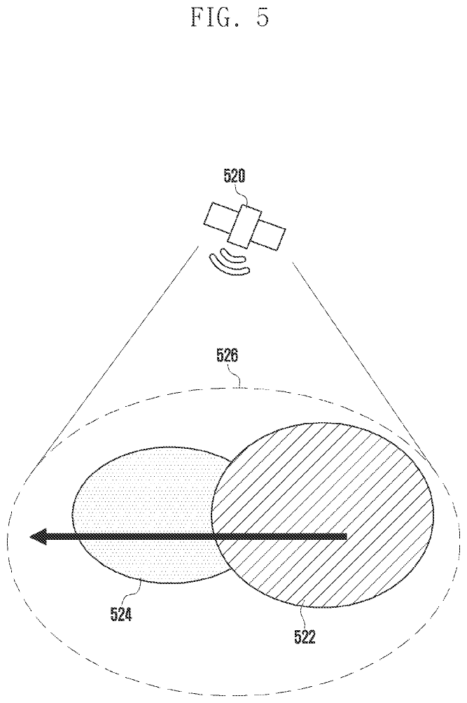

FIG. 5 is a diagram illustrating a situation in which an electronic device moves to coverage of a cell for providing another service according to various embodiments.

The electronic device 101 may be located on a first coverage 522 within coverage 526 of a network of non-terrestrial wireless communication 520. On the first coverage 522, the electronic device 101 may be connected to a terrestrial wireless communication network other than a network of non-terrestrial wireless communication 520. The electronic device 101 may move from the first coverage 522 to second coverage 524. The first coverage 522 and the second coverage 524 may provide different services from each other. For example, the first coverage 522 may provide a normal communication service (e.g., an SMS MMS call and a video call), as a public land mobile network (PLMN). The PLMN may refer, for example, to a network identification number of a user. As a forbidden PLMN having a relatively lower priority than the PLMN, the second coverage 524 may provide limited services compared to the first coverage 522. For example, it may be difficult to provide an emergency call from the second coverage 524. The communication service is merely provided as an example, and is not limited thereto. The electronic device 101 may be provided with limited services only while being moved to the second coverage 524. A terrestrial base station may have a lower priority than a base station of a satellite 520. The priority may refer, for example, to a priority for communication connection with the electronic device 101. The priority may be determined by a method defined by the 3^{rd} generation partnership project (3GPP), but is not limited thereto. The 3GPP may refer, for example, to a standard document for communication. A method for determining priorities may include, for example, a method for allowing access to another PLMN in a decreasing order of a signal quality, determining priorities in random order, referring to priorities stored in a SIM or a ME, or determining priorities so that a home PLMN (HPLMN) among PLMNs has a high priority. When the base station of the satellite 520 has a relatively higher priority than the terrestrial base station, the electronic device 101 may be provided with a service of the base station of the satellite 520 rather than the terrestrial base station. When only a base station for the satellite 520 is found near the electronic device 101, the electronic device 101 may be provided with a service of the base station of the satellite 520 rather than the terrestrial base station.

When the electronic device 101 is connected to the base station of the satellite 520 and is provided with a service therefrom, the connection is performed without consideration of the state of the base station of the satellite 520, and thus the base station of the satellite 520 may be overloaded. The base station of the satellite 520 may fail to provide a specific service (e.g., an emergency call). Accordingly, the usability of the electronic device 101 may deteriorate. In an embodiment below, in order to prevent and/or reduce overload of the base station of the satellite 520 and the deterioration of the usability of the electronic device 101, an operating method of the electronic device 101, which allows the service to be provided from a terrestrial base station having a low priority, is described.

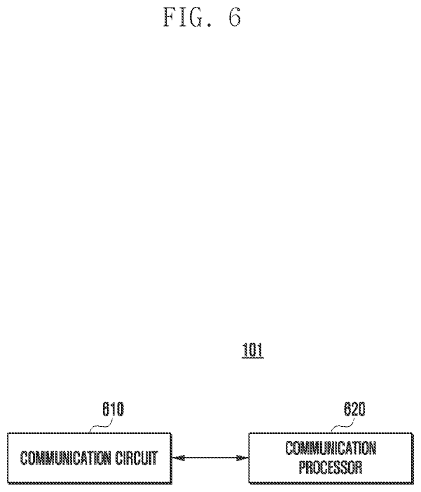

FIG. 6 is a block diagram illustrating an example configuration of an electronic device according to various embodiments.

Referring to FIG. 6, an electronic device (e.g., the electronic device 101 of FIG. 1) according to an embodiment may include a communication circuit 610 (e.g., the wireless communication module 192 of FIG. 1) and/or a communication processor (e.g., including processing circuitry) 620 (e.g., the processor 120 of FIG. 1 and/or the first communication processor 212 and/or the second communication processor 214 of FIG. 2).

The communication circuit 610 may include a communication circuit for supporting first cellular communication and/or second cellular communication, and may provide the electronic device 101 with communication with an external electronic device (e.g., the electronic device 104 of FIG. 1) through the first cellular communication and/or the second cellular communication.

The communication processor 620 may include various processing circuitry (as used herein, including the claims, the term “processor”, “communication processor”, or the like, may include various processing circuitry, including at least one processor, wherein one or more processors of at least one processor may be configured to perform the various functions described herein) and may be operatively connected to the communication circuit 610. The processor 620 may control elements of the electronic device 101. For example, the processor 620 may control elements of the electronic device 101 according to one or more instructions stored in a memory (e.g., the memory 130 of FIG. 1).

The communication processor 620 may transmit and/or receive data through a terrestrial network and/or a non-terrestrial network.

The terrestrial network may refer to a network which can provide data communication through a first node (e.g., the first node 510 of FIG. 5) fixed on the ground.

The non-terrestrial network may refer to a network which can provide data communication through a satellite (e.g., the satellite 520 of FIG. 5) not fixed on the ground.

The communication processor 620 may search for a cell corresponding to another network within a pre-configured (e.g., specified) distance with reference to the location of the electronic device 101, based on the non-terrestrial network having the highest priority with respect to communication connection. An area in which the non-terrestrial network is prioritized to be found may be an area in which there are few cells that are found. In such a situation, it may be difficult to receive an MIB or a SIM signal and search for a cell. For such a reason, the communication processor 620 may search for a cell corresponding to another network within a pre-configured distance with reference to the location of the electronic device 101, based on the non-terrestrial network having the highest priority. The communication processor 620 may determine, based on another network having a lower priority than the non-terrestrial network being found, whether another network having the lower priority supports an emergency call. The communication processor 620 may perform camp-on on another network having the lower priority, based on the emergency call being supported on another network having the lower priority.

The electronic device 101 may perform camp on for a cell and change the state of the electronic device 101 in response to a control channel of a selected cell. The camp on may refer, for example, to an operation in which the electronic device 101 monitors system information and paging information in a newly selected cell after cell reselection. The electronic device 101 may search for an appropriate cell of a selected PLMN, and then stay in an RRC idle state in the corresponding cell. The electronic device 101 in the RRC idle state may select a cell which can provide possible services.

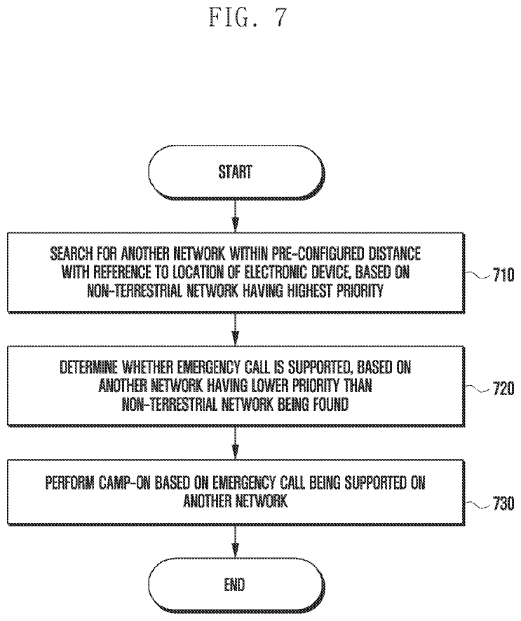

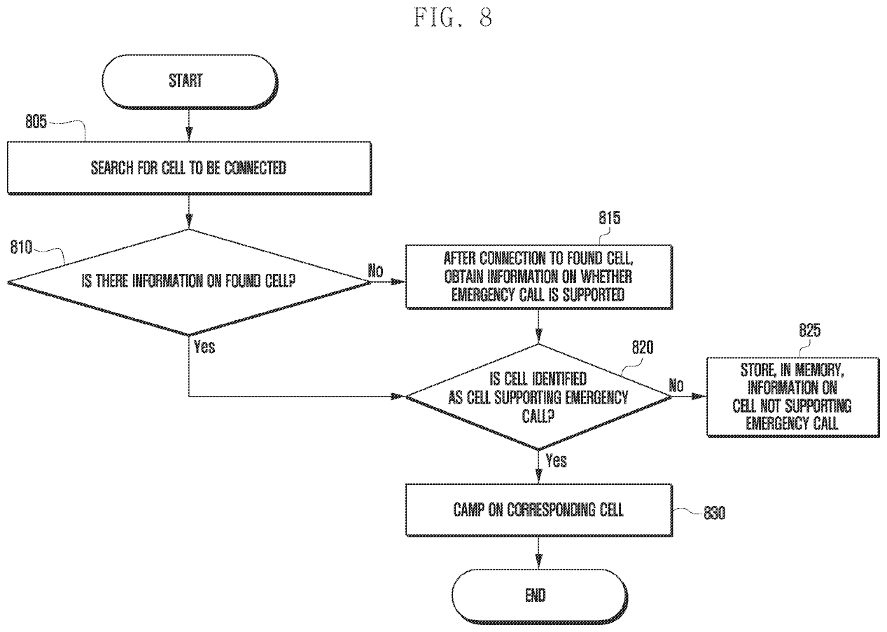

The communication processor 620 may receive, from an external server, information on a base station not supporting an emergency call, or receive information on whether an emergency call is supported, in a process of connecting to at least one network. The communication processor 620 may identify whether a cell found in a process of connecting to a network supports a specific service (e.g., an emergency call), and store the identified information on the memory 130. The communication processor 620 may store the received information on emergency call support in the memory, as a list, and may determine, using the list, whether another network having a low priority supports an emergency call. The information on the emergency call support may be already stored in the memory 130 of the electronic device 101. An embodiment relating thereto will be described in greater detail below with reference to FIGS. 7 and 8.

The communication processor 620 may determine, using the information on emergency call support, whether a specific network supports an emergency call. The information on emergency call support may include at least one of a public land mobile network (PLMN) (MCC+MNC), a cell ID, a band, a bandwidth, a frequency, a master information block (MIB), or a system information block (SIB). The PLMN may refer, for example, to a unique identification number assigned to each communication network. The identification number of the PLMN may include a mobile country code (MCC) and a mobile network code (MNC). The SIB may refer, for example, to information for communication between the electronic device and a wireless communication system when the electronic device 101 accesses the wireless communication system.

The communication processor 620 may search for a cell within a pre-configured distance (e.g., 25 km), based on GPS location information of the electronic device 101, and may determine the type of a service provided by each cell found using the information on emergency call support and the type of a service provided by a cell having the highest priority. The pre-configured distance is merely provided as an example, and may vary according to a configuration. An area in which the non-terrestrial network is prioritized to be found may correspond to an area in which there are few cells that are found. In such a situation, it may be difficult to search for a cell while receiving an MIB or a SIM signal. For such a reason, the communication processor 620 may search for a cell corresponding to another network within a pre-configured distance with reference to the location of the electronic device 101, based on the non-terrestrial network having the highest priority.

The communication processor 620 may determine, based on an emergency call not being supported on the non-terrestrial network, whether the electronic device 101 can simultaneously use the terrestrial network and the non-terrestrial network, and may search for a cell corresponding to another network at each pre-configured period in a non-terrestrial network-connected state. The communication processor 620 may perform searching again at each pre-configured period, based on the cell corresponding to another network not being found. The communication processor 620 may perform camp-on also with another network in the non-terrestrial network-connected state, based on the cell corresponding to another network being found.

Based on a request for the emergency call not being detected for a designated time interval after camp-on on another network having the low priority, the communication processor 620 may release the camp-on with another network having the lower priority, and perform camp-on on a non-terrestrial network having the highest priority.

Based on a request for a specific service supported on the non-terrestrial network having the highest priority being detected after the camp-on on another network having the low priority, the communication processor 620 may release the camp-on with another network having the low priority, and perform camp-on on the non-terrestrial network having the highest priority.

The communication processor 620 may identify whether support for the specific service is possible on another network having the low priority, based on the request for the specific service supported on the non-terrestrial network having the highest priority being detected after communication connection on another network having the low priority is established. Based on the support for the specific service being impossible on another network having the low priority, the communication processor 620 may release the camp-on with another network having the low priority, and may perform the camp-on on the non-terrestrial network having the highest priority.

The communication processor 620 may search for a cell corresponding to another network within a pre-configured distance (e.g., 25 km) with reference to the location of the electronic device 101, based on the non-terrestrial network having the highest priority with respect to communication connection. An area in which the non-terrestrial network is prioritized to be found may correspond to an area in which there are few cells that are found. In such a situation, it may be difficult to search for a cell while receiving an MIB or a SIM signal. For such a reason, the communication processor 620 may search for a cell corresponding to another network within a pre-configured distance with reference to the location of the electronic device 101, based on the non-terrestrial network having the highest priority. The communication processor 620 may perform camp-on on the non-terrestrial network having the highest priority, based on the cell corresponding to another network not being found within the pre-configured distance.

The communication processor 620 may determine whether a newly found network supports an emergency call, based on a change in the location of the electronic device, or a change in a cell found with reference to the location of the electronic device. The communication processor 620 may perform camp-on on the newly found network, based on the emergency call being supported on the newly found network.

FIG. 7 is a flowchart illustrating an example operation of an electronic device according to various embodiments.

The operations described through FIG. 7 may be implemented based on instructions which can be stored in a computer recording medium or a memory (e.g., the memory 130 of FIG. 1). The illustrated method may be executed by an electronic device (e.g., the electronic device 101 of FIG. 1) described through FIGS. 1 to 6, and the technical features described above may not be repeated below. The sequence of the respective operations of FIG. 7 may be changed, some operations may be omitted, and some operations may be simultaneously performed.

In operation 710, a communication processor (e.g., the communication processor 620 of FIG. 6) may search for another network within a pre-configured distance with reference to the location of an electronic device, based on a non-terrestrial network having the highest priority. The non-terrestrial network may refer, for example, to a network for providing a satellite base station.

The priority may refer, for example, to a priority for communication connection with the electronic device 101. The priority may be determined by a method defined by the 3^{rd} generation partnership project (3GPP). When a base station of a satellite (e.g., the satellite 520 of FIG. 5) has a relatively higher priority than a terrestrial base station, a service of the base station of the satellite 520, rather than the terrestrial base station, may be prioritized to be provided to the electronic device 101. When only a base station for the satellite 520 is found near the electronic device 101, a service of the base station of the satellite 520, rather than the terrestrial base station, may be prioritized to be provided to the electronic device 101. However, when the electronic device 101 is connected to the base station of the satellite 520 and is provided with a service therefrom, the connection is performed without consideration of the state of the base station of the satellite 520, and thus the base station of the satellite 520 may be overloaded. Alternatively, the base station of the satellite 520 may fail to provide a specific service (e.g., an emergency call). For such a reason, the communication processor 620 may stop the connection and search for another network, instead of establishing communication connection to the non-terrestrial network in a situation in which the non-terrestrial network has the highest priority.

In operation 720, the communication processor 620 may determine whether an emergency call is supported, based on another network having a lower priority than the non-terrestrial network being found. The network having the lower priority may refer, for example, to a terrestrial network supported through the terrestrial base station. The terrestrial network may support a specific service (e.g., an emergency call), unlike the non-terrestrial network. The communication processor 620 may consider whether the specific service (e.g., the emergency call) is supported, instead of performing communication connection with the non-terrestrial network, in a situation in which the non-terrestrial network has a relatively high priority, and the terrestrial network has a relatively low priority.

In operation 730, the communication processor 620 may perform camp-on, based on the emergency call being supported on another network. The camp-on may refer, for example, to monitoring, by the electronic device 101, system information and paging information in a newly connected cell after cell reselection. In a situation in which the non-terrestrial network has a relatively high priority and the terrestrial network has a relatively low priority, the communication processor 620 may perform the camp-on with the terrestrial network, based on the non-terrestrial network not supporting the specific service (e.g., the emergency call) and the terrestrial network supports the specific service (e.g., the emergency call). The camp-on may refer, for example, to monitoring, by the electronic device 101, system information and paging information in a newly connected cell after cell reselection.

FIG. 8 is a flowchart illustrating an example network searching operating of an electronic device according to various embodiments.

The operations described through FIG. 8 may be implemented based on instructions which can be stored in a computer recording medium or a memory (e.g., the memory 130 of FIG. 1). The illustrated method may be executed by an electronic device (e.g., the electronic device 101 of FIG. 1) described through FIGS. 1 to 6, and the technical features described above may not be repeated below. The sequence of the respective operations of FIG. 8 may be changed, some operations may be omitted, and some operations may be simultaneously performed.

In operation 805, a communication processor (e.g., the communication processor 620 of FIG. 6) may search for a cell to be connected. A base station may refer, for example, to an entity for providing a communication service, and a call may refer, for example, to a search area of the base station.

In operation 810, the communication processor 620 may identify, based on a cell being found, information on the found cell. The information on the cell may include information on whether a specific service (e.g., an emergency call) is provided.

In operation 820, the communication processor 620 may identify, based on the information on the found cell being identified (“Yes” in operation 810), whether the cell provide the specific service (e.g., the emergency call).

The communication processor 620 may acquire (or receive), based on the information on the found cell not being identified in operation 810 (“No” in operation 810), information on whether the specific service (e.g., the emergency call) is supported, after connection to the found cell in operation 815.

Based on the found cell supporting the specific service (e.g., the emergency call) in operation 820 (“Yes” in operation 820), the communication processor 620 may determine to camp on the corresponding cell in operation 830. The camp-on may refer, for example, to monitoring, by the electronic device 101, system information and paging information in a newly selected cell after cell reselection.

Based on the found cell not supporting the specific service (e.g., the emergency call) in operation 820 (“No” in operation 820), the communication processor 620 may store information on the found cell not supporting the specific service (e.g., the emergency call), in the memory 130 in operation 825. Thereafter, when the same cell is found, the communication processor 620 may identify whether the found cell supports the specific service (e.g., the emergency call) using the information stored in the memory 130. The communication processor 620 may search for a network to be connected again in operation 805, based on the found cell not supporting the specific service (e.g., the emergency call).

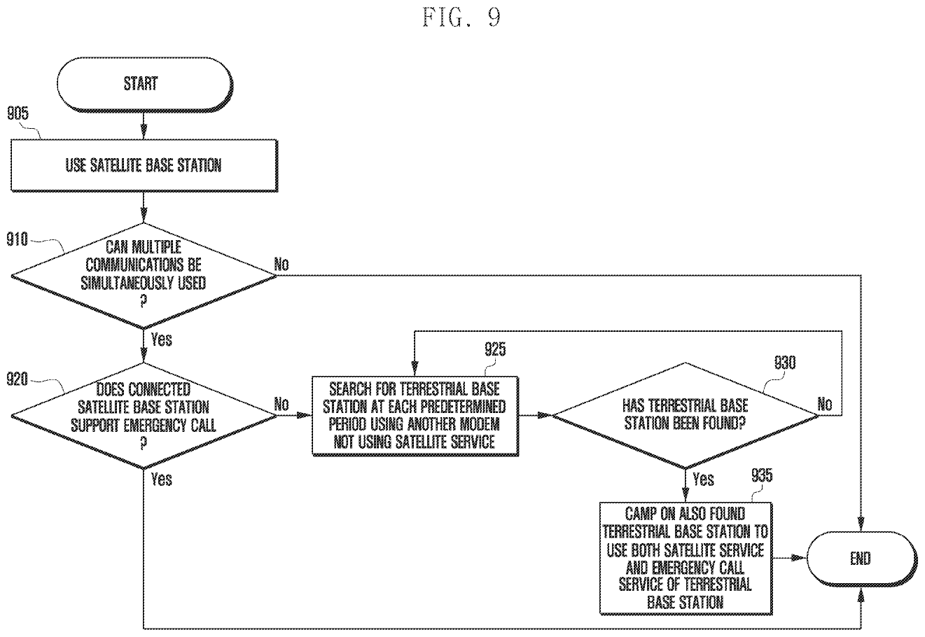

FIG. 9 is a flowchart illustrating an example operation of receiving multiple services by an electronic device according to various embodiments.

The operations described through FIG. 9 may be implemented based on instructions which can be stored in a computer recording medium or a memory (e.g., the memory 130 of FIG. 1). The illustrated method may be executed by an electronic device (e.g., the electronic device 101 of FIG. 1) described through FIGS. 1 to 6, and the technical features described above may not be repeated below. The sequence of the respective operations of FIG. 9 may be changed, some operations may be omitted, and some operations may be simultaneously performed.

In operation 905, a communication processor (e.g., the communication processor 620 of FIG. 6) may be connected to a satellite base station in a situation in which a terrestrial base station is not found. The communication processor 620 may be connected to a satellite base station, based on a priority in a situation in which the terrestrial base station is found.

In operation 910, the communication processor 620 may determine whether the electronic device 101 can be simultaneously connected to multiple communications (e.g., the terrestrial network and the non-terrestrial network). The operation of being simultaneously connected to the multiple networks may refer, for example, to a dual active. The communication processor 620 may terminate the operation, based on the determination that it is difficult for electronic device 101 to simultaneously use the multiple communications.

The communication processor 620 may determine, based on the determination in operation 910 that the electronic device 101 can simultaneously use the multiple communications (“Yes” in operation 910), whether the connected satellite base station supports a specific service (e.g., an emergency call), in operation 920. The communication processor 620 may terminate the operation, based on the connected satellite base station supporting the specific service (e.g., the emergency call) in operation 920.

The communication processor 620 may search for a terrestrial base station at each predetermined period using another modem not using a satellite service in operation 925, based on the connected satellite base station not supporting the specific service (e.g., the emergency call) in operation 920. The communication processor 620 may be operatively connected to a communication circuit (e.g., the communication circuit 610 of FIG. 6). The processor 620 may control elements of the electronic device 101. For example, the processor 620 may control elements of the electronic device 101 according to one or more instructions stored in a memory (e.g., the memory 130 of FIG. 1). The communication circuit 610 is a communication circuit supporting first cellular communication and/or second cellular communication, and may provide the electronic device 101 with communication with an external electronic device (e.g., the electronic device 104 of FIG. 1) through the first cellular communication and/or the second cellular communication. The communication circuit 610 may support various technologies for securing performance in a high-frequency band, for example technologies such as beamforming, massive multiple-input and multiple-output (MIMO), full dimensional MIMO (FD-MIMO), an array antenna, analog beam-forming, or a large-scale antenna.

In operation 930, the communication processor 620 may identify whether the terrestrial base station is found. Based on the terrestrial base station being found in operation 930, the communication processor 620 may perform camp-on also on the found terrestrial base station, and simultaneously use a service of the satellite base station and a service of the terrestrial base station in operation 935. Based on the terrestrial base station not being found in operation 930, the communication processor 620 may again search for a terrestrial base station at each predetermined period using another modem not using a satellite service, in operation 925. Thereafter, the communication processor 620 may search for the terrestrial base station at each predetermined period. The predetermined period may refer, for example, to three minutes or five minutes, and may vary according to a configuration. In addition, the communication processor 620 may also search for another base station, based on the location of the electronic device 101 changes while exceeding a designated distance (e.g., a radius of 20 km) from a reference location. The designated distance is merely provided as an example, and may vary according to a configuration. The reference location may refer, for example, to the location of the electronic device 101 in a situation in which the non-terrestrial network is found to have the highest priority. An area in which the non-terrestrial network is prioritized to be found may correspond to an area in which there are few cells that are found. In such a situation, it may be difficult to search for a cell while receiving an MIB or a SIM signal. For such a reason, the communication processor 620 may search for a cell corresponding to another network within a pre-configured distance with reference to the location of the electronic device 101, based on the non-terrestrial network having the highest priority.

An electronic device according to various example embodiments may include: a communication circuit configured to support cellular communication through a terrestrial network and a non-terrestrial network, a memory configured to store mapping data obtained by mapping identification information of the non-terrestrial network and a service supported by the non-terrestrial network, and at least one communication processor. One or more of the at least one communication processor may be configured to search for a cell corresponding to another network within a specified distance with reference to a location of the electronic device, based on the non-terrestrial network having a highest priority with respect to communication connection, determine, based on another network having a lower priority than the non-terrestrial network being found, whether an emergency call is supported on another network having the lower priority, and perform, based on the emergency call being supported on another network having the lower priority, camp-on on another network having the lower priority, wherein the camp-on includes monitoring, by the electronic device, system information and paging information in a newly selected cell based on cell reselection.

According to various example embodiments, one or more of the at least one communication processor may be configured to: receive, from an external server, information on a base station not supporting the emergency call, or receive information on whether the emergency call is supported, in a process of connecting with at least one network, store information on the received information on emergency call support in the memory, as a list, and determine whether the emergency call is supported on another network having the lower priority using the list.

According to various example embodiments, the information on emergency call support may include at least one of a PLMN (MCC+MNC), a cell ID, a band, a bandwidth, a frequency, or a system information block (SIB), and one or more of the at least one communication processor may be configured to determine whether a specific network supports an emergency call using the information on emergency call support.

According to various example embodiments, one or more of the at least one communication processor may be configured to search for a cell within a specified distance, based on GPS location information of the electronic device, and determine a type of a service provided by each cell found using the information on emergency support and a type of a service provided by a cell having a highest priority.

According to various example embodiments, one or more of the at least one communication processor may be configured to: determine whether the electronic device can simultaneously use the terrestrial network and the non-terrestrial network, based on the emergency call not being supported on the non-terrestrial network, search for a cell corresponding to another network at each specified period in a non-terrestrial network-connected state, perform searching again at each specified period, based on a cell corresponding to another network not being found, and perform camp-on also with another network in the non-terrestrial network-connected state, based on the cell corresponding to another network being found.

According to various example embodiments, based on a request for an emergency call not being detected for a designated time interval based on performing camp-on on another network having the lower priority, one or more of the at least one communication processor may be configured to release the camp-on with another network having the lower priority, and perform camp-on with the non-terrestrial network having the highest priority.

According to various example embodiments, based on a request for a specific service supported on the non-terrestrial network having the highest priority based on performing the camp-on on another network having the lower priority, one or more of the at least one communication processor may be configured to release the camp-on with another network having the lower priority, and perform camp-on with the non-terrestrial network having the highest priority.

According to various example embodiments, based on a request for a specific service supported on the non-terrestrial network having the highest priority being detected based on communication connection being established on another network having the lower priority, one or more of the at least one communication processor may be configured to: identify whether support for a specific service is possible on another network having the lower priority, release the camp-on with another network having the lower priority, based on support for the specific service being impossible on another network having the lower priority, and perform the camp-on with the non-terrestrial network having the highest priority.

According to various example embodiments, one or more of the at least one communication processor may be configured to: search for a cell corresponding to another network within a specified distance with reference to a location of the electronic device, based on the non-terrestrial network having a highest priority with respect to communication connection, and perform camp-on with the non-terrestrial network having the highest priority, based on the cell corresponding to another network not being found within the specified distance.

According to various example embodiments, based on a change in the location of the electronic device, or a change in a cell found with reference to the location of the electronic device, one or more of the at least one communication processor may be configured to: determine whether an emergency call is supported on a newly found network, and perform camp-on on the newly found network, based on the emergency call being supported on the newly found network.

According to various example embodiments, a method of operating an electronic device for satellite communication may include: searching for a cell corresponding to another network within a specified distance with reference to a location of the electronic device, based on the non-terrestrial network having a highest priority with respect to communication connection, determining, based on another network having a lower priority than the non-terrestrial network being found, whether an emergency call is supported on another network having the lower priority, and performing camp-on on another network having the lower priority, based on the emergency call being supported on another network having the lower priority, wherein the camp-on may include monitoring, by the electronic device, system information and paging information in a newly selected cell based on cell reselection.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication circuit configured to support cellular communication through a terrestrial network and a non-terrestrial network;
a memory configured to store mapping data obtained by mapping identification information of the non-terrestrial network and a service supported by the non-terrestrial network; and
at least one communication processor,
wherein one or more of the at least one communication processor is configured to:
search for a cell corresponding to another network within a specified distance with reference to a location of the electronic device, based on the non-terrestrial network having a highest priority with respect to communication connection;
based on another network having a lower priority than the non-terrestrial network being found, determine whether an emergency call is supported on another network having the lower priority; and
based on the emergency call being supported on another network having the lower priority, perform camp-on on another network having the lower priority, and
wherein the camp-on includes monitoring, by the electronic device, system information and paging information in a newly selected cell based on cell reselection.

2. The electronic device of claim 1, wherein one or more of the at least one communication processor is configured to:
receive, from an external server, information of a base station not supporting the emergency call, or receive information on whether the emergency call is supported, in a process of connecting with at least one network;
store information on the received information on emergency call support in the memory; and
determine whether the emergency call is supported on another network having the lower priority based on the information stored in the memory.

3. The electronic device of claim 2, wherein the information on emergency call support comprises at least one of a public land mobile network (PLMN) (mobile country code (MCC)+mobile network code (MNC)), a cell ID, a band, a bandwidth, a frequency, or a system information block (SIB), and
wherein one or more of the at least one communication processor is configured to determine whether a specific network supports an emergency call using the information on emergency call support.

4. The electronic device of claim 2, wherein one or more of the at least one communication processor is configured to:
search for a cell within a specified distance, based on global positioning satellite (GPS) location information of the electronic device; and
determine a type of a service provided by each cell found using the information on emergency call support and a type of a service provided by a cell having a highest priority.

5. The electronic device of claim 1, wherein one or more of the at least one communication processor is configured to:
determine whether the electronic device can simultaneously use the terrestrial network and the non-terrestrial network, based on the emergency call not being supported on the non-terrestrial network;
search for a cell corresponding to another network at each specified period in a non-terrestrial network-connected state;
perform searching again at each specified period, based on a cell corresponding to another network not being found; and
perform camp-on also with another network in the non-terrestrial network-connected state, based on the cell corresponding to another network being found.

6. The electronic device of claim 1, wherein one or more of the at least one communication processor is configured to, based on a request for an emergency call not being detected for a designated time interval based on camp-on on another network having the lower priority being performed:
release the camp-on with another network having the lower priority; and
perform camp-on with the non-terrestrial network having the highest priority.

7. The electronic device of claim 1, wherein one or more of the at least one communication processor is configured to, based on a request for a specific service supported on the non-terrestrial network having the highest priority being detected based on the camp-on on another network having the lower priority being performed:
release the camp-on with another network having the lower priority; and
perform camp-on with the non-terrestrial network having the highest priority.

8. The electronic device of claim 1, wherein one or more of the at least one communication processor is configured to, based on a request for a specific service supported on the non-terrestrial network having the highest priority being detected based on a communication connection being established on another network having the lower priority:
identify whether support for a specific service is possible on another network having the lower priority;
release the camp-on with another network having the lower priority, based on support for the specific service being impossible on another network having the lower priority; and
perform the camp-on with the non-terrestrial network having the highest priority.

9. The electronic device of claim 1, wherein one or more of the at least one communication processor is configured to:
search for the cell corresponding to another network within the specified distance with reference to the location of the electronic device, based on the non-terrestrial network having the highest priority with respect to communication connection; and
perform camp-on with the non-terrestrial network having the highest priority, based on the cell corresponding to another network not being found within the specified distance.

10. The electronic device of claim 1, wherein one or more of the at least one communication processor is configured to, based on a change in the location of the electronic device, or a change in a cell found with reference to the location of the electronic device:
determine whether an emergency call is supported on a newly found network; and
perform camp-on on the newly found network, based on the emergency call being supported on the newly found network.

11. A method of operating an electronic device for satellite communication, the method comprising:
searching for a cell corresponding to another network within a specified distance with reference to a location of the electronic device, based on the non-terrestrial network having a highest priority with respect to communication connection;
based on another network having a lower priority than the non-terrestrial network being found, determining whether an emergency call is supported on another network having the lower priority; and
based on the emergency call being supported on another network having the lower priority, performing camp-on on another network having the lower priority, and
wherein the camp-on includes monitoring, by the electronic device, system information and paging information in a newly selected cell based on cell reselection.

12. The method of claim 11, wherein the determining of whether the emergency call is supported on another network having the lower priority comprises:
receiving, from an external server, information of a base station not supporting the emergency call, or acquiring information on whether the emergency call is supported, in a process of connecting with at least one network;
storing information on the received information on emergency call support in a memory; and
determining whether the emergency call is supported on another network having the lower priority using the information stored in the memory.

13. The method of claim 12, wherein the determining of whether the emergency call is supported on another network having the lower priority further comprises determining whether a specific network supports an emergency call using the received information on emergency call support, and
wherein the information on emergency call support comprises at least one of a public land mobile network (PLMN) (mobile country code (MCC)+mobile network code (MNC)), a cell ID, a band, a bandwidth, a frequency, or a system information block (SIB).

14. The method of claim 12, further comprising:
searching for a cell within a specified distance, based on global positioning satellite (GPS) location information of the electronic device; and
determining a type of a service provided by each cell found using the received information on emergency call support and a type of a service provided by a cell having a highest priority.

15. The method of claim 11, further comprising:
determining whether the electronic device can simultaneously use the terrestrial network and the non-terrestrial network, based on the emergency call not being supported on the non-terrestrial network;
searching for a cell corresponding to another network at each specified period in a non-terrestrial network-connected state;
performing searching again at each specified period, based on a cell corresponding to another network not being found; and
performing camp-on also with another network in the non-terrestrial network-connected state, based on the cell corresponding to another network being found.

16. The method of claim 11, further comprising, based on a request for an emergency call not being detected for a designated time interval based on camp-on on another network having the lower priority being performed:
releasing the camp-on with another network having the lower priority; and
performing camp-on with the non-terrestrial network having the highest priority.

17. The method of claim 11, further comprising, based on a request for a specific service supported on the non-terrestrial network having the highest priority being detected based on the camp-on on another network having the lower priority being performed:
releasing the camp-on with another network having the lower priority; and
performing camp-on with the non-terrestrial network having the highest priority.

18. The method of claim 11, further comprising, based on a request for a specific service supported on the non-terrestrial network having the highest priority being detected based on a communication connection being established on another network having the lower priority:
identifying whether support for a specific service is possible on another network having the lower priority;
releasing the camp-on with another network having the lower priority, based on support for the specific service being impossible on another network having the lower priority; and
performing the camp-on with the non-terrestrial network having the highest priority.

19. The method of claim 11, further comprising:
searching for the cell corresponding to another network within the specified distance with reference to the location of the electronic device, based on the non-terrestrial network having the highest priority with respect to communication connection; and
performing camp-on with the non-terrestrial network having the highest priority, based on the cell corresponding to another network not being found within the specified distance.

20. The method of claim 11, further comprising, based on a change in the location of the electronic device, or a change in a cell found with reference to the location of the electronic device:
determining whether an emergency call is supported on a newly found network; and
performing camp-on on the newly found network, based on the emergency call being supported on the newly found network.
